(19) United States
(12) Patent Application Publication
(10) Pub. No.: US 2004/0050223 A1
(43) Pub. Date: Mar. 18, 2004

(54) Apparatus and method for cutting fiber-reinforced gypsum and/or cement

(76) Inventors: Jesse Renecker, Kingston, WA (US); Jonathan Edwards, Bremerton, WA (US)

Correspondence Address: PERKINS COIE LLP, PATENT-SEA, P.O. BOX 1247, SEATTLE, WA, 98111-1247, US

(21) Appl. No.: 10/244,818

(22) Filed: Sep. 16, 2002

(51) Int. Cl. B26D 1/00; B26D 3/00

(52) U.S. Cl. 83/13

(57) ABSTRACT

Blade assemblies for reciprocating wallboard tools and methods for cutting wallboard are disclosed herein. In one embodiment, the blade assembly includes first and second fingers attachable to a cutting tool, and a reciprocating cutting member between the first and second fingers. The cutting member can have a body pivotally coupled to the first and second fingers, and a blade projecting from the body. In one embodiment, the blade can have a top surface with an arcuate portion having a generally constant radius defining a cutting surface that is at least approximately coterminous with a distal end. In another embodiment, the blade can have a top surface with an arcuate portion having a radius of greater than approximately 2 inches. In another embodiment, the distal end of the blade can have a nose with a radius of at least approximately 0.3 inch. In another embodiment, the blade can also include a tail projecting away from the top surface. The tail is configured to follow the framing while the blade assembly is cutting.

### TECHNICAL FIELD

The present invention relates to apparatuses and methods for cutting fiber-reinforced gypsum and/or fiber-reinforced cement materials.

### BACKGROUND

Wallboard is used to form walls and ceilings in the construction of residential and commercial buildings. Plasterboard, plywood and other materials can be used as wallboard. Plasterboard, the most commonly used, is typically made of several plies of paper bonded to a hardened gypsum core. Plasterboard is widely used because it provides a smooth, attractive surface that can be easily painted or wallpapered.

Plasterboard, however, can be dented, broken or punctured relatively easily. Its relatively weak strength makes it less suitable for high-impact applications (e.g., loading docks, prisons, college dorms). Fiber-reinforced plasterboard, however, has been developed specifically for high-impact applications. One such product is Fiberock® manufactured by U.S. Gypsum Company. It is composed of gypsum and recycled paper or cellulose, but it does not have a heavy paper lining bonded to the exterior surface. Fiber-reinforced plasterboard (also known as fiber-reinforced gypsum) provides superior strength and durability relative to standard plasterboard. With its increased strength and stiffness, it is much more likely to resist denting, breaking and puncturing. Accordingly, it is desirable to use fiber-reinforced plasterboard in applications where improved strength is necessary.

One disadvantage of using fiber-reinforced plasterboard is that, unlike standard plasterboard, fiber-reinforced plasterboard is difficult to cut. Standard plasterboard can be scored with a knife and then easily broken or snapped along the score. After it is snapped, the paper lining can be trimmed on the uncut side with a pair of scissors or a sharp knife. Furthermore, irregular angles and circular cuts can be made with a jigsaw. Fiber-reinforced plasterboard, however, generally cannot be cut using the score and snap method because the fibers in the plasterboard prevent a clean, attractive break. The rough, uneven break in fiber-reinforced gypsum precludes, for practical purposes, using the score and snap method. Cutting fiber-reinforced plasterboard with a saw is also not feasible because the saw generates large amounts of fine dust that create a very unpleasant working environment.

Fiber-reinforced plasterboard is even more difficult to cut once it has been nailed, screwed or otherwise fixed to a wall or ceiling. Sometimes, it is desirable to cut out a window, door or vent after the fiber-reinforced plasterboard has been installed. Conventional blades, including blades for cutting fiber-cement materials disclosed in U.S. Pat. Nos. 5,993,303 and 6,250,998 (which are herein incorporated by reference), and other blades for cutting sheet metal are not well suited for cutting fiber-reinforced plasterboard after it has been hung for several reasons. First, conventional blades may not track along the framing to achieve straight, precise cuts when cutting out an area for a window, door, or other opening. Second, conventional blades may fail prematurely or cause premature failure of the drive assembly or motor assembly when cutting fiber-reinforced plasterboard. Third, conventional fiber-cement blades may not be able to cut out a corner of a framed window or door. Fourth, conventional blades may chew-up a cross-member of the adjoining framing when cutting out a window or door. Fifth, conventional fiber-cement blades may rip through fiber-reinforced plasterboard causing the plasterboard to crack along unpredictable paths.

### SUMMARY

The present invention is directed toward blade assemblies for cutting fiber-reinforced wallboard and other fiber-reinforced materials, cutting tools having such blade assemblies, and methods for cutting fiber-reinforced materials. In one embodiment, a blade assembly has first and second fingers attachable to a cutting tool. The first finger has a first guide surface and a first interior surface, and the second finger has a second guide surface and a second interior surface. The first and second interior surfaces are spaced apart from one another, and the first and second guide surfaces define a guide plane. The guide surfaces, for example, can be flat, planar surfaces that position the cutting tool at a desired angle relative to a workpiece.

The blade assembly also has a reciprocating cutting member between the first and second fingers. The cutting member has a body pivotally coupled to the first and second fingers and a blade projecting from the body. The blade has a first side surface facing the first interior surface of the first finger, a second side surface facing the second interior surface of the second finger, and a top surface between the first and second side surfaces. In one embodiment, the top surface has an arcuate portion with a generally constant radius defining a cutting surface that is at least approximately coterminous with a distal end of the blade. The arcuate portion of the top surface, for example, can have a radius of greater than approximately 2 inches. At least part of the arcuate portion is configured to be a cutting surface. In another embodiment, the top surface has an arcuate portion with a generally constant radius for an arc length of at least approximately 1.8 inches. In another embodiment, the distal end of the blade includes a nose with an rounded portion having a radius of at least approximately 0.3 inch. In another embodiment, the blade can also include a tail projecting away from the top surface. The tail is configured to follow the framing while the blade assembly is cutting.

An embodiment of a method for cutting wallboard includes contacting a first surface of the wallboard with guide surfaces of two spaced apart fingers of a cutting tool. The method further includes reciprocating a blade between the fingers along a stroke having an open position and a closed position. The blade has a cutting surface that contacts the wallboard at the distal tip of the blade in the closed position. The method further includes moving the wallboard and/or the cutting tool relative to the other along a cutting path.

### BRIEF DESCRIPTION OF THE DRAWINGS

FIG. 1 is an isometric view of a hand-held cutting tool with a blade assembly in accordance with one embodiment of the invention.

FIG. 2 is a side elevational view of the blade assembly of FIG. 1.

FIG. 3 is a top plan view of the blade assembly of FIG. 2.

FIG. 4A is a side view of a portion of the blade assembly of FIG. 2 with the cutting member shown in an open position and a closed position.

FIG. 4B is a side view of a portion of a prior art blade assembly with a cutting member shown in an open position and a closed position.

FIG. 5A is a side view of a portion of a blade assembly with the cutting member shown in an open position and a closed position in accordance with another embodiment of the invention.

FIG. 5B is a side view of a portion of the prior art blade assembly of FIG. 4B.

FIG. 6 is a side view of a portion of a blade assembly with the cutting member shown in an open position and a closed position in accordance with another embodiment of the invention.

FIG. 7A is a side view of a portion of the blade assembly of FIG. 2 with the cutting member shown in an open position and a closed position.

FIG. 7B is a side view of a portion of the prior art blade assembly of FIG. 4B.

FIG. 8 is a top plan view illustrating cuts made by the blade assemblies of FIGS. 7A and 7B.

FIG. 9 is a side elevational view of a cutting member in accordance with another embodiment of the invention.

### DETAILED DESCRIPTION

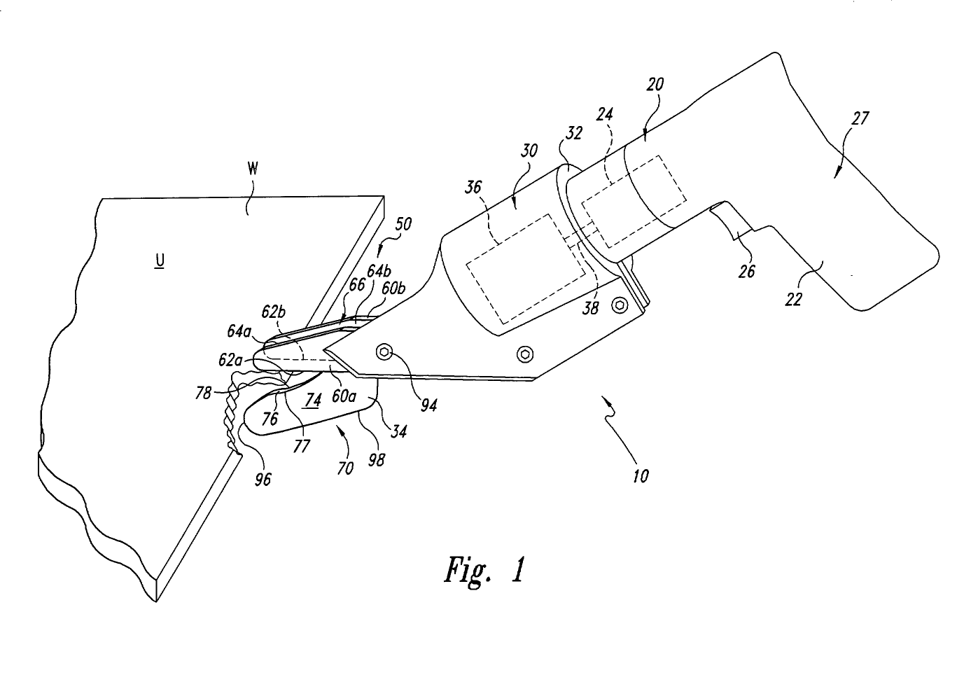

The present invention is an apparatus for cutting interior wallboard or exterior siding products. Many specific details of certain embodiments of the invention are set forth in the following description and in FIGS. 1-9 to provide a thorough understanding of such embodiments. One skilled in the art, however, will understand that the present invention may have additional embodiments, or that the invention may be practiced without several of the details described in the following description. For example, even though many embodiments are described with reference to cutting fiber-reinforced gypsum, they can also be used to cut fiber-reinforced cement materials and other building products.

FIG. 1 is an isometric view of a hand-held cutting tool 10 with a blade assembly 50 in accordance with one embodiment of the invention. The cutting tool 10 also includes a motor unit 20 and a head 30 attached to the motor unit 20. The blade assembly 50 is attached to the head 30 and includes a cutting member 70, a first finger 60a on one side of the cutting member 70, and a second finger 60b on the other side of the cutting member 70. The cutting member 70 reciprocates between the fingers 60a-b for cutting a workpiece W.

The motor unit 20 of the illustrated embodiment includes a housing 22, a motor 24 (shown schematically in phantom) inside the housing 22, and a switch 26 operatively coupled to the motor 24. The housing 22 has a handle 27 configured to be gripped by an operator. Suitable electric motor units 20 are the No. 3208-90 electric motor manufactured by Black and Decker Corporation and No. 0201-60 electric motor manufactured by Milwaukee Electric Tool Corporation. Suitable pneumatic motor units 20 are the No. 7802 pneumatic motor manufactured by Ingersoll-Rand Corporation and the No. 1446E-SLH pneumatic motor manufactured by Sioux Tools Incorporated.

In the illustrated embodiment, the output of the motor unit 20 is converted into a reciprocal motion by the head 30 which has a casing 32 and a reciprocating drive assembly 36 (shown schematically in phantom). The casing 32 is attached to the housing 22 of the motor unit 20. Additionally, the reciprocating drive assembly 36 is coupled to the motor 24 via a gear assembly 38 (shown schematically in phantom) to translate the rotational output from the motor unit 20 into a reciprocating motion. A suitable drive assembly is disclosed in U.S. Pat. No. 4,173,069, entitled “Power Shear Head,” which is herein incorporated by reference.

In the embodiment shown in FIG. 1, the first finger 60a is attached to one side of the head 30, the second finger 60b is attached to the other side of the head 30, and the cutting member 70 pivots between the first and second fingers 60a and 60b . The first finger 60a is separable from the second finger 60b . In alternative embodiments, the first and second fingers 60a and 60b can be portions (for example, integral portions) of a single alignment member. In the illustrative embodiment, the first finger 60a has a guide surface 62a and a first interior surface 64a generally transverse to the guide surface 62a . Similarly, the second finger 60b has a second guide surface 62b (shown in phantom) and a second interior surface 64b generally transverse to the guide surface 62b . The first and second fingers 60a and 60b are attached to the head 30 to leave a space between the first and second interior surfaces 64a and 64b that defines a gap 66 in which the cutting member 70 may be received. Additionally, the first and second guide surfaces 62a and 62b are generally flat to rest on an upper surface U of the wallboard workpiece W for aligning the cutting member 70 with the workpiece W. In other embodiments, only a portion of the guide surfaces 62a-b are flat.

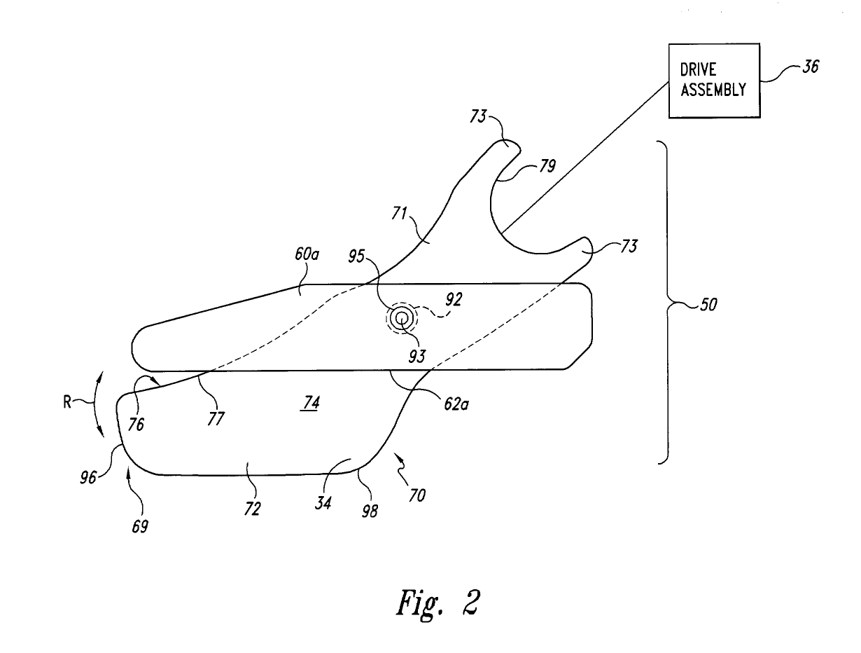

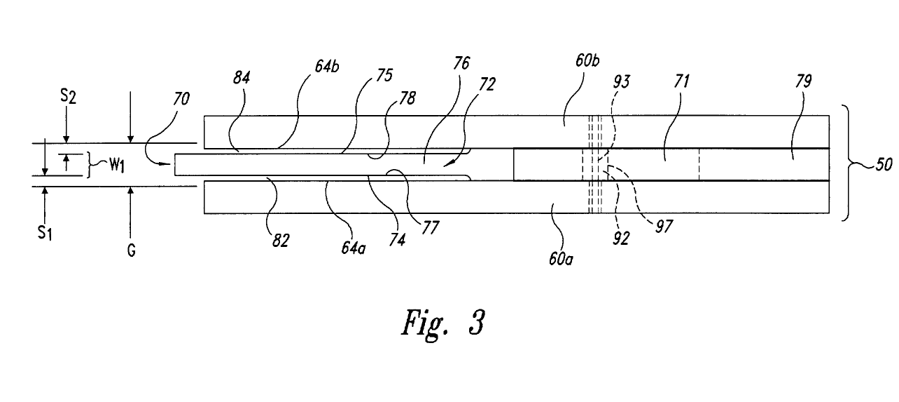

FIG. 2 is a side view and FIG. 3 is a top plan view of the blade assembly 50 illustrated in FIG. 1. The cutting member 70 has a body portion 71 with a first width approximately equal to a gap distance G (shown in FIG. 3) between the first interior surface 64a of the first finger 60a and the second interior surface 64b of the second finger 60b . In alternate embodiments, the body 71 can have a width less than the gap distance G and one or more spacers (not shown) can be placed between the body 71 and the interior surfaces 64a-b of the fingers 60a-b. The cutting member 70 also has a blade 72 projecting from the body 71 between the first and second fingers 60a and 60b . The blade 72 has a first side surface 74 facing toward the first interior surface 64a , a second side surface 75 (FIG. 3) facing toward the second interior surface 64b , a curved top surface 76, and a front surface 96 (FIG. 2). Referring to FIG. 3, the edge along the top surface 76 and the first side surface 74 defines a first cutting edge 77, and the edge along the top surface 76 and the second side surface 75 defines a second cutting edge 78.

FIG. 3 also shows the spacing between the blade 72 and the fingers 60a-b. The first side surface 74 is spaced apart from the first interior surface 64a by a distance S₁ to define a first side space 82. Similarly, the second side surface 75 is spaced apart from the second interior surface 64b by a distance S₂ to define a second side space 84. The distances S₁ and S₂ of the first and second side spaces 82 and 84 may be a function of the thickness and the type of fiber-reinforced material of the workpiece W. For example, in one embodiment when the workpiece W is a fiber-reinforced gypsum wallboard with a thickness of approximately 0.625 inch, the distances S₁ and S₂ are between 0.05 and 0.06 inch and the gap width G is approximately 0.25 inch. In other embodiments, the distances S₁ and S₂ can be different for cutting a workpiece with a different thickness or a different fiber-reinforced material. For example, when the workpiece W is a fiber-cement panel or plank with a thickness of 0.25-0.3125 inch, the side distances S₁ and S₂ are between 0.035 and 0.049 inch, and the gap width G is approximately 0.25 inch. The spacing between the first and second side surfaces 74 and 75 and the fingers 60a-b can be selected by adjusting the width of the top surface 76 of the blade 72. In one embodiment with a gap width G of 0.25 inch between the fingers 60a-b, the width of top surface 76 of the blade 72 can be approximately 0.14 inch. The thickness of the blade 72 for cutting fiber-reinforced gypsum is generally less than that used for cutting fiber cement materials because fiber-reinforced gypsum tends to rip or crack along unpredictable lines when it is cut with a thicker blade.

Referring back to FIG. 2, the top surface 76 of the cutting member 70 has a generally constant radius of curvature that is concave with respect to the guide surfaces 62a-b of the fingers 60a-b. Accordingly, the first and second cutting edges 77 and 78 are also concave with respect to the wallboard workpiece W. In one embodiment, the top surface 76 has a radius of approximately 3.3 inches. However, in alternative embodiments, the top surface 76 can have any radius greater than 2 inches. The curvature of the top surface 76 is at least approximately coterminous with the distal surface 96. The length of the constant curvature on the top surface 76 provides a long cutting region (the portion of the cutting edges 77 and 78 that cut through the workpiece W) that can cut to the distal end 69 of the blade 72 as the blade 72 moves upward between the fingers 60a-b.

Referring to FIGS. 2 and 3, the reciprocating cutting member 70 is pivotally coupled to the first and second fingers 60a and 60b by a bushing 92. The bushing 92 is generally cylindrical and has two side portions and a center portion with a larger radius. The center portion is received within an aperture 97 in the cutting member 70. The two side portions are received within an aperture 95 in each finger 60. The bushing 92 has an aperture 93 to receive a bolt 94 (shown in FIG. 1) to secure the bushing 92, the fingers 60a-b and the cutting member 70 to the head 30 (FIG. 1). The fingers 60a-b are also fixed to the head 30 by another bolt (not shown), and accordingly, only the cutting member 70 can pivot. In the illustrated embodiment, the fingers 60 are removable so that they can be changed when worn. Furthermore, the first finger 60a is at least similar to the second finger 60b so that the fingers 60a-b are interchangeable. In other embodiments, each finger 60 can have the same or similar ends so that the fingers 60a-b can be turned around when one end is worn.

The reciprocating cutting member 70 in the illustrated embodiment has a driven end 79 configured to engage the reciprocating drive assembly 36 of the head 30. The driven end 79 has two spaced-apart fingers 73 that are alternately engaged by a rotating cam of the drive assembly 36. In operation, the motor 24 actuates the drive assembly 36 when an operator depresses the switch 26. The drive assembly 36 reciprocates the blade 72 of the cutting member 70 along a reciprocating path R between an open position and a closed position. In the open position, the top surface 76 of the blade 72 is below the guide surfaces 62a-b of the fingers 60a-b. In the closed position, the top surface 76 of the blade 72 is above the guide surfaces 62a-b of the fingers 60a-b. In one embodiment, the blade 72 reciprocates at approximately 100-3,000 strokes per minute. As the blade 72 moves from the open position to the closed position, the first cutting edge 77 and the first interior surface 64a shear the wallboard workpiece W along one line, and the second cutting edge 78 and the second interior surface 64b shear the wallboard workpiece W along a parallel line. The top surface 76, accordingly, lifts and separates a cut section (not shown) of the wallboard workpiece W with each upward stroke of the cutting member 70. To cut a continuous line through the workpiece W, an operator pushes the cutting tool 10 across the workpiece W as the cutting member 70 reciprocates.

There are several advantages to embodiments of the tool 10 that increase the cutting region and shift the cutting region toward the distal end 69 of the cutting member 70. For example, increasing the length of the cutting region extends the useful life of the blade assembly 50. The life of the blade assembly 50 is extended because the cutting edges 77 and 78 of the cutting member 70 can cut more material with each stroke so that fewer strokes are required to cut the material.

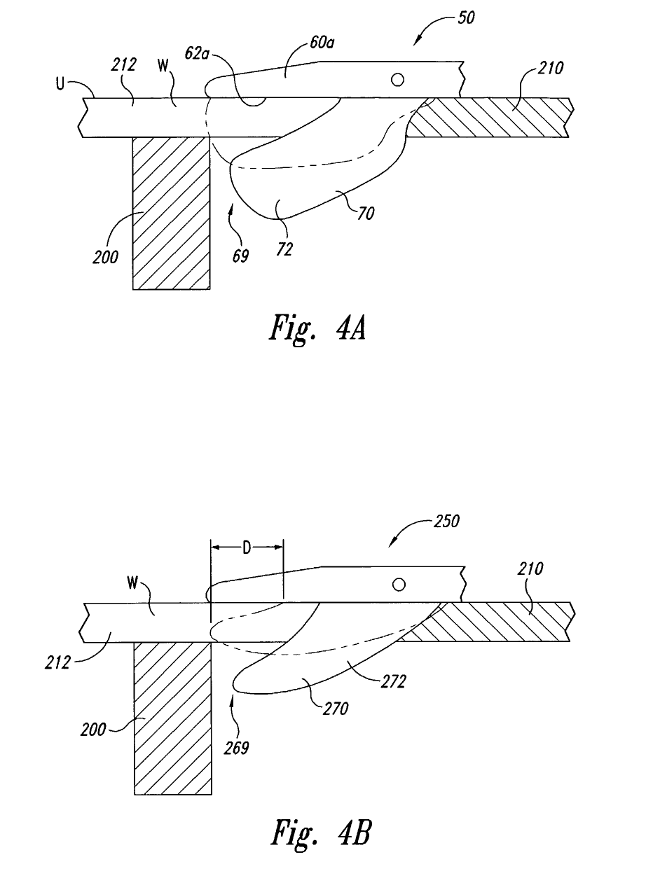

Another benefit of several embodiments of the tool 10 is that they can cut out corners of a hole for installing windows and door in pre-hung sheets of wallboard within a framed structure. FIGS. 4A and 4B illustrate that increasing the length of the cutting region and shifting the region to the distal end 69 of the cutting member 70 permits the blade assembly 50 to cut out corners. FIG. 4A is a side view of a portion of the blade assembly 50 of FIG. 2 with the cutting member 70 shown in an open position (solid line) and a closed position (broken line). In the illustrated embodiment, the guide surface 62a of the first finger 60a contacts the upper surface U of the workpiece W. At this point with the blade 70 in the open position, the workpiece W includes a cut portion 210 and an uncut portion 212. Having the cutting region extend to the distal end 69 of the blade 72 is advantageous because the blade 72 cuts the workpiece W all the way out to the distal end 69 when the blade 72 is in the closed position. As such, the blade assembly 50 can cut out corners (such as around windows, vents and doors) even when the distal end 69 of the blade 72 rubs against a cross-member 200 of the framing and precludes further forward movement of the tool. By contrast, FIG. 4B is a side view of a portion of a prior art blade assembly 250 with a cutting member 270 in an open position (solid line) and a closed position (broken line). The prior art cutting member 270 cannot cut a section D of the workpiece W because the cutting surface on the prior art cutting member 270 does not extend to a distal end 269 of a blade 272, and because the cross-member 200 of the framing precludes further forward movement of the cutting member 270. Furthermore, shifting the cutting region toward the distal end 69 of the blade 72 lengthens the life of the motor 24 (FIG. 1) and the drive assembly 36 (FIG. 1) by decreasing the amount of dust generated during the cutting process that accumulates on a bushing 92 (FIG. 2). Decreasing the dust that accumulates on the bushing 92 reduces the stress and loads on these components.

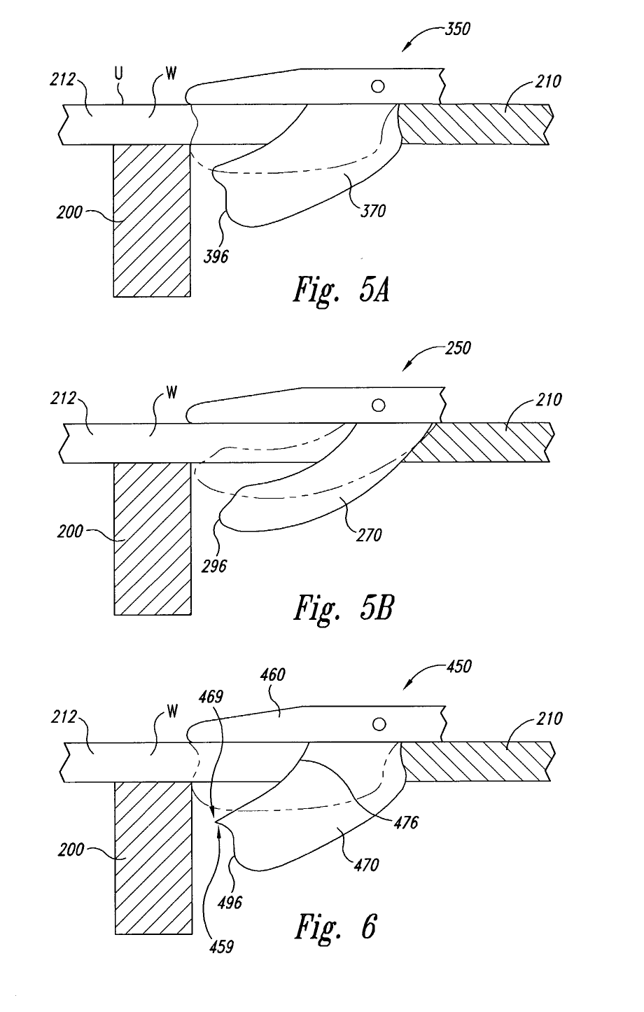

FIG. 5A is a side view of a portion of a blade assembly 350 with a cutting member 370 shown in an open position (solid line) and a closed position (broken line) in accordance with another embodiment of the invention. In the illustrated embodiment, the cutting member 370 has a front surface 396 having an arcuate portion with a radius of approximately 0.46 inch. In alternative embodiments, the cutting member 370 can have a front surface 396 with a different radius of curvature, or without a radius of curvature at all. The large radius of curvature allows the front surface 396 to contact the cross-member 200 of the framing without damaging the cross-member 200. The blade assembly 350 can thus cut an opening in the workpiece W that extends all the way to the cross-member 200 without damaging the cross-member 200. FIG. 5B is a side view of a portion of the prior art blade assembly 250 of FIG. 4B with the cutting member 270 shown in an open position (solid line) and a intermediate position (broken line). The smaller radius of curvature on a front surface 296 increases the probability that the cutting member 270 will rip up the cross-member 200 as the cutting member 270 repeatedly strikes it. The smaller radius of curvature can thus cause a piece of the cross-member 200 to break off as the cutting member 270 reciprocates between the open and closed positions.

FIG. 6 is a side view of a portion of a blade assembly 450 shown in an open position (solid line) and a closed position (broken line) in accordance with still another embodiment of the invention. In the illustrated embodiment, the blade assembly 450 includes fingers 460 and a cutting member 470 having a tip 459 at a distal end 469. The tip 459 is formed by extending a top surface 476 in the direction of the distal end 469 at approximately the same radius. A front surface 496 is also concave toward the extension of the top surface 476 to form the tip 459. The tip 459 can lengthen the cutting region on the top surface 476 and further assist the blade assembly 450 in cutting out corners, as discussed above.

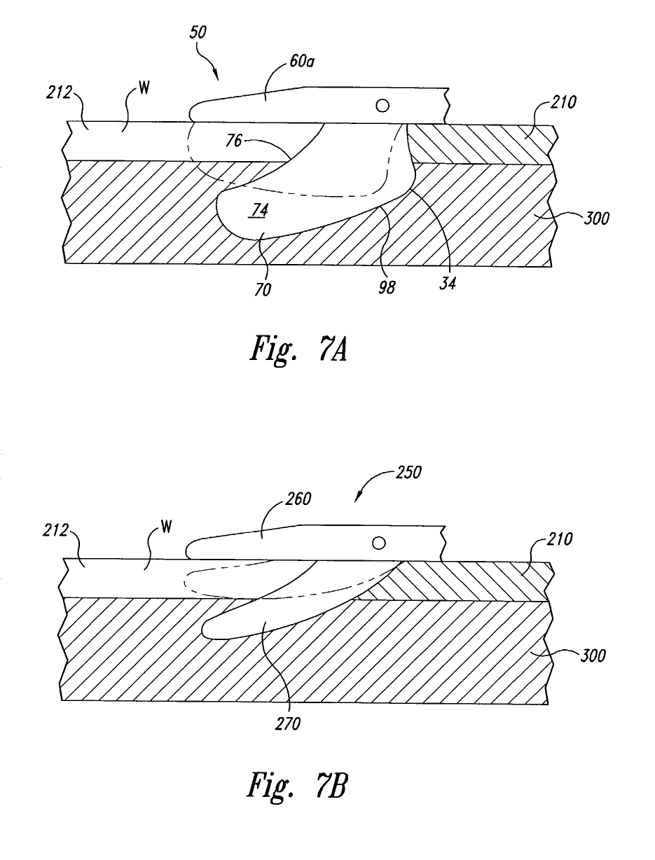

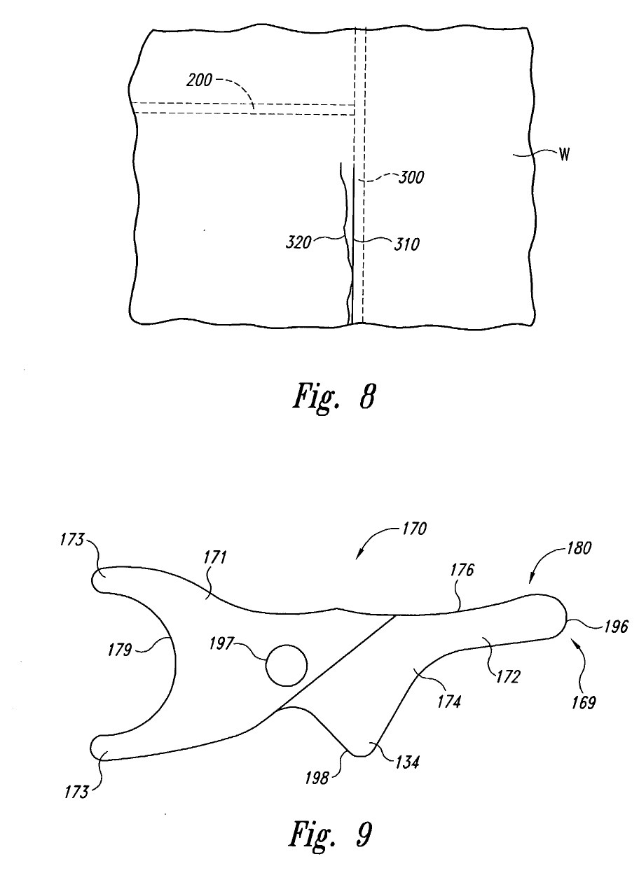

FIG. 7A is a side view of a portion of the blade assembly 50 of FIG. 2. In the illustrated embodiment, the bottom surface 98 of the cutting member 70 has a tail 34 that projects away from the top surface 76. The sides of the tail 34 are formed by the first side surface 74 and the second side surface 75 (FIG. 3). The tail 34 projects below the workpiece W sufficiently to ride along the side of a framing 300 as the blade assembly 50 reciprocates between the open (solid line) and closed (broken line) positions and moves through the workpiece W. FIG. 8 is a top plan view illustrating a straight and accurate cut 310 that can be made in the workpiece W when the tail 34 (FIG. 7A) rides along the framing 300. The tail 34 allows the operator to use the framing 300 as a guide to make accurate and straight cuts through the workpiece W. This is useful when cutting an opening, such as for a window or door. In alternative embodiments, the cutting member 70 might not have a tail 34, or might have a tail 34 with a different configuration. FIG. 7B is a side view of a portion of the prior art blade assembly 250 of FIG. 4B in which the cutting member 270 does not have a tail 34. The prior art blade assembly 250 cannot use the framing 300 as a guide because in the closed position (broken line) the cutting member 270 is not configured to remain in contact with the framing 300. Often the result, as demonstrated in FIG. 8, is an inaccurate cut 320.

FIG. 9 is a side view of a cutting member 170 configured to cut the workpiece W along a reduced radius arcuate path in accordance with another embodiment of the invention. In the illustrated embodiment, the cutting member 170 includes a body portion 171 having a driven end 179 with two fingers 173, and a blade portion 172 having a top surface 176, a front surface 196 and a bottom surface 198 with a tail 134. A distal portion of the front surface 196 and a portion of the bottom surface 198 extend in the same general direction to form a finger 180 at the distal end 169 of the blade 172. The finger 180 allows the cutting member 170 to turn with a reduced radius because of the decreased surface area of the side surfaces 174 on the blade 172. In alternative embodiments, the side surfaces 174 can be canted, such that as they extend from the top surface 176 they converge towards each other.

From the foregoing, it will be appreciated that specific embodiments of the invention have been described herein for purposes of illustration, but that various modifications may be made without deviating from the spirit and scope of the invention. Accordingly, the invention is not limited, except as by the appended claims.

I/We claim:

1. A blade assembly for a reciprocating wallboard cutting tool, comprising:
a first finger attachable to a cutting tool, the first finger having a first guide surface and a first interior surface transverse to the first guide surface;
a second finger attachable to the cutting tool, the second finger having a second guide surface and a second interior surface transverse to the second guide surface, the first and second interior surfaces being spaced apart from one another, and the first and second guide surfaces defining a guide plane; and
a reciprocating cutting member between the first and second fingers, the cutting member having a body and a blade projecting from the body, the body being pivotally coupled to the first and second fingers, the blade having a first side surface facing the first interior surface of the first finger, a second side surface facing the second interior surface of the second finger, and a top surface between the first and second side surfaces, the top surface having an arcuate portion with a radius of greater than approximately 2 inches, wherein at least part of the arcuate portion is configured to be a cutting surface.

2. The blade assembly of claim 1 wherein the width of the body is approximately 0.25 inch.

3. The blade assembly of claim 1 wherein the width of a portion of the top surface of the blade is approximately 0.14 inch.

4. The blade assembly of claim 1 wherein the top surface of the blade has a concave curvature with respect to the first and second fingers.

5. The blade assembly of claim 1, further comprising a tip at the distal end of the top surface.

6. The blade assembly of claim 1, further comprising a first spacer between the first finger portion and the cutting member and a second spacer between the second finger portion and the cutting member.

7. The blade assembly of claim 1, further comprising a nose at the distal end of the blade having a radius of at least approximately 0.3 inch.

8. The blade assembly of claim 1, further comprising a tail projecting away from the top surface, wherein the tail is configured to follow a framing while the blade assembly is cutting.

9. The blade assembly of claim 1, further comprising a bottom surface having a first distal portion, wherein the top surface has a second distal portion and the first distal portion and second distal portion extend generally in at least a similar direction to form a finger.

10. The blade assembly of claim 1 wherein the blade is configured to make an arcuate cut in the wallboard having a radius of less than 3 inches.

11. A blade assembly for a reciprocating wallboard cutting tool, comprising:
a first finger attachable to a cutting tool, the first finger having a first guide surface and a first interior surface transverse to the first guide surface;
a second finger attachable to the cutting tool, the second finger having a second guide surface and a second interior surface transverse to the second guide surface, the first and second interior surfaces being spaced apart from one another, and the first and second guide surfaces defining a guide plane; and
a reciprocating cutting member between the first and second fingers, the cutting member having a body and a blade projecting from the body, the body being pivotally coupled to the first and second fingers, the blade having a first side surface facing the first interior surface of the first finger, a second side surface facing the second interior surface of the second finger, and a top surface between the first and second side surfaces, the top surface having an arcuate portion with a generally constant radius for an arc length of at least approximately 1.8 inches.

12. The blade assembly of claim 11 wherein the width of a portion of the top surface of the blade is approximately 0.14 inch.

13. The blade assembly of claim 11, further comprising a tip at the distal end of the top surface.

14. The blade assembly of claim 11, further comprising a nose at the distal end of the blade having a radius of at least approximately 0.3 inch.

15. The blade assembly of claim 11, further comprising a bottom surface having a first distal portion, wherein the top surface has a second distal portion and the first distal portion and second distal portion extend generally in at least a similar direction to form a finger.

16. The blade assembly of claim 11 wherein the blade is configured to make an arcuate cut in the wallboard having a radius of less than 3 inches.

17. The blade assembly of claim 11, further comprising a tail projecting away from the top surface, wherein the tail is configured to follow a framing while the blade assembly is cutting.

18. A blade assembly for a reciprocating wallboard cutting tool, comprising:
a first finger attachable to a cutting tool, the first finger having a first guide surface and a first interior surface transverse to the first guide surface;
a second finger attachable to the cutting tool, the second finger having a second guide surface and a second interior surface transverse to the second guide surface, the first and second interior surfaces being spaced apart from one another, and the first and second guide surfaces defining a guide plane; and
a reciprocating cutting member between the first and second fingers, the cutting member having a body and a blade projecting from the body, the body being pivotally coupled to the first and second fingers, the blade having a first side surface facing the first interior surface of the first finger, a second side surface facing the second interior surface of the second finger, a top surface between the first and second side surfaces, and a distal end, the top surface having an arcuate portion with a generally constant radius defining a cutting surface that is at least approximately coterminous with the distal end.

19. A blade assembly for a reciprocating wallboard cutting tool, comprising:
a first finger attachable to a cutting tool, the first finger having a first guide surface and a first interior surface;
a second finger having a second guide surface and a second interior surface, the second finger being attachable to the tool to space the first and second interior surfaces apart from each other; and
a reciprocating cutting member between the first and second fingers, the cutting member having a body and a blade projecting from the body, the body being pivotally coupled to the first and second fingers, the blade having a first side surface facing the first interior surface of the first finger, a second side surface facing the second interior surface of the second finger, a top surface between the first and second side surfaces, and a nose at the distal end of the blade, the nose having an arcuate portion with a radius of at least approximately 0.3 inch.

20. The blade assembly of claim 19 wherein the width of a portion of the top surface of the blade is approximately 0.14 inch.

21. The blade assembly of claim 19, further comprising a tip at the distal end of the top surface.

22. The blade assembly of claim 19 wherein the top surface has an arcuate portion with a radius of greater than 2 inches, wherein at least part of the arcuate portion is configured to be a cutting surface.

23. The blade assembly of claim 19, further comprising a tail projecting away from the top surface, wherein the tail is configured to follow a framing while the blade assembly is cutting.

24. The blade assembly of claim 19 wherein the arcuate portion has a radius of between 0.4 inch and 0.5 inch.

25. A blade assembly for a reciprocating wallboard cutting tool, comprising:
a first finger attachable to a cutting tool, the first finger having a first guide surface and a first interior surface;
a second finger having a second guide surface and a second interior surface, the second finger being attachable to the tool to space the first and second interior surfaces apart from each other; and
a reciprocating cutting member between the first and second fingers, the cutting member having a body and a blade projecting from the body, the body being pivotally coupled to the first and second fingers, the blade having a first side surface facing the first interior surface of the first finger, a second side surface facing the second interior surface of the second finger, a top surface between the first and second side surfaces, and a tail projecting away from the top surface, the tail being configured to follow a framing while the blade assembly is cutting.

26. The blade assembly of claim 25 wherein the width of a portion of the top surface of the blade is approximately 0.14 inch.

27. The blade assembly of claim 25, further comprising a tip at the distal end of the top surface.

28. The blade assembly of claim 25 wherein the top surface has an arcuate portion with a radius of greater than 2 inches, wherein at least part of the arcuate portion is configured to be a cutting surface.

29. The blade assembly of claim 25, further comprising a nose at the distal end of the blade having a radius of at least approximately 0.3 inch.

30. The blade assembly of claim 25, further comprising a bottom surface having a first distal portion, wherein the top surface has a second distal portion and the first distal portion and second distal portion extend generally in at least a similar direction to form a finger.

31. The blade assembly of claim 25 wherein the blade is configured to make an arcuate cut in the wallboard having a radius of less than 3 inches.

32. A blade assembly for a reciprocating wallboard cutting tool, comprising:
a first finger attachable to a cutting tool, the first finger having a first guide surface and a first interior surface;
a second finger having a second guide surface and a second interior surface, the second finger being attachable to the tool to space the first and second interior surfaces apart from each other; and
a reciprocating cutting member between the first and second fingers, the cutting member having a body and a blade projecting from the body, the body being pivotally coupled to the first and second fingers, the blade having a first side surface facing the first interior surface of the first finger, a second side surface facing the second interior surface of the second finger, a top cutting surface between the first and second side surfaces, a nose defining a distal end of the blade, the top cutting surface having a first arcuate portion with a radius extending along an arc length to be at least approximately coterminous with a distal most portion of the nose, the nose having a front surface configured to slide across a frame member, and a tail projecting away from the top surface, wherein the tail is configured to follow a framing while the blade assembly is cutting.

33. The blade assembly of claim 32 wherein the width of a portion of the top surface of the blade is approximately 0.14 inch.

34. The blade assembly of claim 32, further comprising a tip at the distal end of the top surface.

35. The blade assembly of claim 32 wherein the top surface has an arcuate portion with a radius of greater than 2 inches, wherein at least part of the arcuate portion is configured to be a cutting surface.

36. A wallboard cutting tool, comprising:
a hand-held motor unit having a housing, a motor inside the housing, and a switch operatively coupled to the motor to selectively activate the motor;
a head having a casing attached to the housing of the motor unit and a reciprocating drive assembly coupled to the motor;
a first finger attachable to the head or the motor unit, the first finger having a first guide surface and a first interior surface transverse to the first guide surface;
a second finger attachable to the head or the motor unit, the second finger having a second guide surface and a second interior surface transverse to the second guide surface, the first and second interior surfaces being spaced apart from one another, and the first and second guide surfaces defining a guide plane; and
a reciprocating cutting member between the first and second fingers, the cutting member having a body and a blade projecting from the body, the body being operatively coupled to the reciprocating drive assembly and pivotally coupled to the first and second fingers for reciprocating the cutting member between the fingers, the blade having a first side surface facing the first interior surface of the first finger, a second side surface facing the second interior surface of the second finger, and a top surface between the first and second side surfaces, the top surface having an arcuate portion with a radius of greater than approximately 2 inches, wherein at least part of the arcuate portion is configured to be a cutting surface.

37. A wallboard cutting tool, comprising:
a hand-held motor unit having a housing, a motor inside the housing, and a switch operatively coupled to the motor to selectively activate the motor;
a head having a casing attached to the housing of the motor unit and a reciprocating drive assembly coupled to the motor;
a first finger attachable to the head or the motor unit, the first finger having a first guide surface and a first interior surface transverse to the first guide surface;
a second finger attachable to the head or the motor unit, the second finger having a second guide surface and a second interior surface transverse to the second guide surface, the first and second interior surfaces being spaced apart from one another, and the first and second guide surfaces defining a guide plane; and
a reciprocating cutting member between the first and second fingers, the cutting member having a body and a blade projecting from the body, the body being operatively coupled to the reciprocating drive assembly and pivotally coupled to the first and second fingers for reciprocating the cutting member between the fingers, the blade having a first side surface facing the first interior surface of the first finger, a second side surface facing the second interior surface of the second finger, a top surface between the first and second side surfaces, and a nose defining a distal end of the blade, the top surface having an arcuate portion with a radius extending along an arc length to be at least substantially coterminous with a distal most portion of the nose, the nose having a front surface configured to slide across a frame member.

38. A wallboard cutting tool, comprising:
a hand-held motor unit having a housing, a motor inside the housing, and a switch operatively coupled to the motor to selectively activate the motor;
a head having a casing attached to the housing of the motor unit and a reciprocating drive assembly coupled to the motor;
a first finger attachable to the head or the motor unit, the first finger having a first guide surface and a first interior surface;
a second finger having a second guide surface and a second interior surface, the second finger being attachable to the head or the motor unit to space the first and second interior surfaces apart from each other; and
a reciprocating cutting member between the first and second fingers, the cutting member having a body and a blade projecting from the body, the body being operatively coupled to the reciprocating drive assembly and pivotally coupled to the first and second fingers for reciprocating the cutting member between the fingers, the blade having a first side surface facing the first interior surface of the first finger, a second side surface facing the second interior surface of the second finger, a top surface between the first and second side surfaces, and a front surface along the distal end of the blade defining a rounded nose of the blade, the nose having an arcuate portion with a radius of at least approximately 0.3 inch.

39. A wallboard cutting tool, comprising:
a hand-held motor unit having a housing, a motor inside the housing, and a switch operatively coupled to the motor to selectively activate the motor;
a head having a casing attached to the housing of the motor unit and a reciprocating drive assembly coupled to the motor;
a first finger attachable to the motor unit or the head, the first finger having a first guide surface and a first interior surface,
a second finger having a second guide surface and a second interior surface, the second finger being attachable to the motor unit or the head to space the first and second interior surfaces apart from each other; and
a reciprocating cutting member between the first and second fingers, the cutting member having a body and a blade projecting from the body, the body being pivotally coupled to the first and second fingers, the blade having a first side surface facing the first interior surface of the first finger, a second side surface facing the second interior surface of the second finger, a top surface between the first and second side surfaces, and a tail projecting away from the top surface, the tail being configured to follow a framing while the blade assembly is cutting.

40. A method for cutting wallboard, comprising:
contacting a first surface of the wallboard with guide surfaces of two spaced apart finger portions of a cutting tool;
reciprocating a blade between the fingers along a stroke having an open position and a closed position, wherein a cutting surface at a distal tip of the blade contacts the wallboard at the distal tip of the blade in the closed position; and
moving the wallboard and/or the cutting tool relative to the other along a cutting path.

41. The method of claim 40 wherein contacting a first surface of the wallboard includes contacting a first surface of fiber-reinforced gypsum.

42. A method for cutting wallboard, comprising:
contacting a first surface of the wallboard with guide surfaces of two spaced apart fingers of a cutting tool, the wallboard being attached to a framing;
reciprocating the blade between the fingers in a direction transverse to the guide plane along a stroke between an open position and a closed position, the blade having a tail that projects below the fingers in the closed position by a distance to contact a side portion of the framing under the wallboard; and
moving the cutting tool along a cutting path, wherein the tail rides against the side portion of the framing between the open and closed positions.

43. The method of claim 42 wherein contacting a first surface of the wallboard includes contacting a first surface of fiber-reinforced gypsum.
